(19) United States
(12) Patent Application Publication
(10) Pub. No.: US 2008/0061971 A1
(43) Pub. Date: Mar. 13, 2008

(54) METHOD FOR ALERTING A USER TO ABNORMAL PERFORMANCE OF AN APPARATUS

(76) Inventor: Sung-Ken Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/555,674

(22) Filed: Nov. 1, 2006

(30) Foreign Application Priority Data
Aug. 31, 2006 (TW) 095215428

(51) Int. Cl. G08B 13/14; G06F 11/00

(52) U.S. Cl. 340/568.1; 726/35

(57) ABSTRACT

To alert a user to an abnormal performance, such as motion/vibration, a loss of power, or a loss of a signal indicating theft of an apparatus, such as a liquid crystal display or a plasma display, an anti-theft function of the apparatus is initiated, and when the abnormal performance of the apparatus is detected, an alarm is triggered.

### BACKGROUND OF THE INVENTION

1. Field of the Invention

The present invention relates to theft prevention methods, and more particularly, to a method of alerting a user to abnormal performance of an apparatus.

2. Description of the Prior Art

Most security systems today operate a network of apparatuses, such as video cameras, video monitors, video recorders, and other related apparatuses. Where in the past many of these apparatuses were bulky and heavy, i.e. hard to move around, new advances in video monitor and video recording technology have decreased the weight and shape/size of the apparatuses.

Although lighter, smaller apparatuses are very convenient for installation, maintenance, and repair, i.e. times when the apparatuses must be moved around, the smaller apparatuses are also more vulnerable to theft. Typically, a thief will unplug an electrical cord of the apparatus from an electrical socket, unplug any interface connectors between the apparatus and another device, unlock or break any external physical restraints on the apparatus, and transport the apparatus away from the original location. Practically speaking, only the external physical restraints are available to prevent theft of the apparatus. However, the external physical restraints, e.g. a chain or a lock, are often easily picked or broken, and do not offer sufficient protection of the apparatus.

### SUMMARY OF THE INVENTION

According to the present invention, a method for alerting a user to an abnormal performance of an apparatus comprises initiating an anti-theft function of the apparatus, and triggering an alarm when the abnormal performance of the apparatus is detected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method of alerting a user to abnormal performance of an apparatus according to the present invention.

FIG. 2 is a detailed flowchart of the method of FIG. 1.

### DETAILED DESCRIPTION

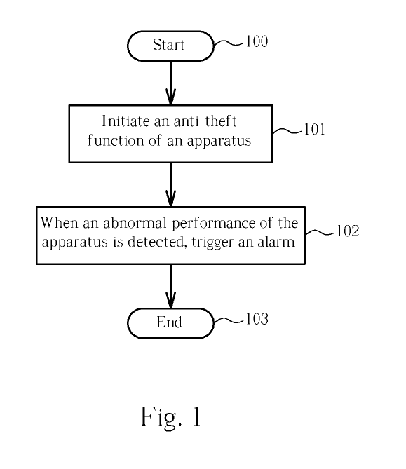

Please refer to FIG. 1, which is a flowchart of a method of alerting a user to an abnormal performance of an apparatus according to the present invention. The apparatus could be a liquid crystal display (LCD) panel, a plasma display, a digital versatile disc (DVD) player, or a digital video recorder (DVR), among other possible apparatuses, particularly moveable apparatuses. The method of alerting the user to the abnormal performance of the apparatus comprises:

Step 100: Start.

Step 101: Initiate an anti-theft function of the apparatus.

Step 102: When the abnormal performance of the apparatus is detected, trigger an alarm.

Step 103: End.

The abnormal performance of the apparatus can include motion or vibration beyond a predetermined threshold, abrupt loss of power due to unplugging the apparatus from an electrical socket or turning off the apparatus with a switch, or a loss of a signal over an interface connection, such as when a video cable is removed from an LCD panel. If any of these types of abnormal performance, which would indicate attempted theft of the apparatus, is detected, then the alarm is triggered to deter the thief and alert the user. When the alarm is triggered, the alarm is buzzed, and the alarm also begins to drain power. If the apparatus is not connected to an electrical power supply, the anti-theft function has a backup battery, which provides enough power to buzz the alarm. If the apparatus is still connected to the electrical power supply, then the apparatus can recharge the battery. The battery can be a rechargeable battery, a nickel-hydrogen (NiH) battery, or an alkaline battery, etc.

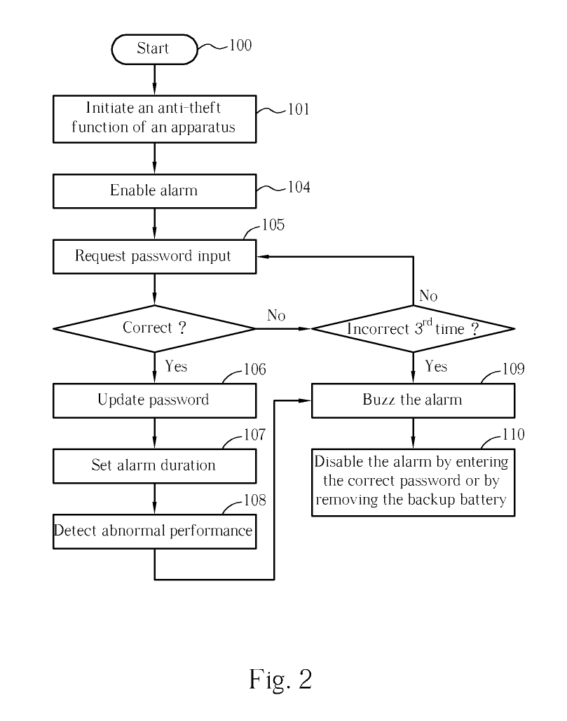

Please refer to FIG. 2, which is a detailed flowchart of the present invention method of alerting the user to the abnormal performance of the apparatus. It should be noted that many steps of the detailed flowchart could be removed, and the order of steps could also be rearranged, as will be obvious through further description and observation. As shown in FIG. 2, the method of alerting the user to the abnormal performance of the apparatus comprises:

Step 100: Start.

Step 101: Initiate the anti-theft function of the apparatus.

Step 104: Enable the alarm.

Step 105: Request password input. If the password input is correct, proceed to Step 106. If the password input is incorrect for fewer than a predetermined number of times, repeat Step 105. If the password input is incorrect for the predetermined number of times, then proceed to Step 109.

Step 106: Update password.

Step 107: Set alarm duration.

Step 108: Detect the abnormal performance.

Step 109: Buzz the alarm.

Step 110: Disable the alarm by entering the correct password or by removing the backup battery.

After initiating the anti-theft function of the apparatus, the alarm is enabled. At this time, the anti-theft function of the apparatus requests that the user enter a password. If the user enters the password correctly, then the user can proceed to change various settings in the anti-theft function, including the password and duration of the alarm. These settings do not need to be changed for the method to achieve the desired effect. Further, the settings could be changed in a different order than shown in FIG. 2. The duration of the alarm can be set to 5 minutes, 10 minutes, or 15 minutes, however any duration could be used to satisfy the spirit of the present invention. The user can also disable the alarm at this time. If the user enters the password incorrectly in Step 105, the anti-theft function requests the user enter the password again, up to the predetermined number of times. Preferably, the predetermined number of times is three. However, this is a design choice, and could be modified. For the example of the predetermined number of times being three, if the user has entered the password incorrectly three times in a row, then the alarm goes off (Step 109). The alarm will also be buzzed if the alarm is enabled and any of the abnormal performances mentioned above is detected by the anti-theft function.

To turn off the alarm actively, the user must either enter the password correctly or remove the backup battery, which supplies power to the alarm. The alarm will turn itself off if the duration of the alarm is exceeded or if the backup battery dies. If the duration of the alarm is exceeded, the alarm resets, and will go off again if the abnormal performance is detected. Of course, some steps mentioned above could be removed without departing from the spirit of the present invention, one example of which is the step of disabling the alarm.

It should further be noted that the present invention method could be implemented in hardware, software, firmware, or any combination of the three.

Therefore, the present invention provides a method of alerting a user when an abnormal performance is detected in an apparatus. By buzzing an alarm, the present invention method alerts the user and also deters a thief from stealing the apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for alerting a user to an abnormal performance of an apparatus comprising:
initiating an anti-theft function of the apparatus; and
when the abnormal performance of the apparatus is detected, triggering an alarm.

2. The method of claim 1 further comprising requesting a password input.

3. The method of claim 2 further comprising updating the password.

4. The method of claim 1 further comprising buzzing the alarm if a password is incorrectly inputted for a predetermined number of times.

5. The method of claim 1 further comprising enabling the alarm.

6. The method of claim 1 further comprising setting a duration of the alarm.

7. The method of claim 1 further comprising providing a backup battery for the alarm.

8. The method of claim 7 further comprising charging the backup battery by power provided to the apparatus.

9. The method of claim 7 further comprising disabling the alarm by removing the backup battery.

10. The method of claim 1 wherein providing the backup battery for the alarm comprises providing a rechargeable battery for the alarm.

11. The method of claim 1 wherein providing the backup battery for the alarm comprises providing a nickel-hydrogen battery for the alarm.

12. The method of claim 1 wherein providing the backup battery for the alarm comprises providing an alkaline battery for the alarm.

13. The method of claim 1 further comprising disabling the alarm by inputting the password.

14. The method of claim 1 initiating the anti-theft function of the apparatus is initiating an anti-theft function of a liquid crystal display (LCD).

15. The method of claim 1 initiating the anti-theft function of the apparatus is initiating an anti-theft function of a plasma panel.

16. The method of claim 1 initiating the anti-theft function of the apparatus is initiating an anti-theft function of an optical disc player.

17. The method of claim 16 initiating the anti-theft function of the optical disc player is initiating an anti-theft function of a digital versatile disc (DVD) player.

18. The method of claim 1 initiating the anti-theft function of the optical disc player is initiating an anti-theft function of a digital video recorder (DVR).

19. The method of claim 1 initiating the anti-theft function of the optical disc player is initiating an anti-theft function of a movable apparatus.

20. The method of claim 1 wherein triggering the alarm is triggering a buzzer.

21. The method of claim 1 further comprising detecting the abnormal performance of the apparatus.
